(19) United States
(12) Patent Application Publication
(10) Pub. No.: US 2019/0302058 A1
(43) Pub. Date: Oct. 3, 2019

(54) REMOTE-FIELD EDDY CURRENT CHARACTERIZATION OF PIPES

(71) Applicant: Halliburton Energy Services, Inc., Houston, TX (US)

(72) Inventors: Reza Khalaj Amineh, Houston, TX (US); Luis Emilio San Martin, Houston, TX (US); Burkay Donderici, Pittsford, NY (US)

(21) Appl. No.: 16/315,896

(22) PCT Filed: Aug. 12, 2016
(86) PCT No.: PCT/US2016/046823

§ 371 Date: Jan. 7, 2019

(51) Int. Cl. G01N 27/90; E21B 47/08; G01V 3/12; G01B 7/06; G01N 27/02

(52) U.S. Cl. CPC G01N 27/9066; E21B 47/082; G01N 27/028; G01B 7/06; G01V 3/12

(57) ABSTRACT

Described are various approaches for estimating the total thickness of a set of pipes from the phase of the mutual impedance between transmitter and receiver measured with an eddy-current logging tool disposed interior to the pipes, in conjunction with a simulated functional relationship between the phase and the total thickness.

### BACKGROUND

The integrity of metal pipes in oil and gas wells is of great importance. Perforations or cracks in production tubing due to corrosion, for example, can cause significant loss of revenue due to loss of hydrocarbons and/or production of unwanted water. The corrosion of the well casing can be an indication of a defective cement bond between the casing and the borehole wall, which is likewise of concern because it can allow uncontrolled migration of fluids between different formation zones or layers. Near the surface, uncontrolled fluid migration can cause contamination of agricultural or drinking water reserves. To prevent damage associated with pipe (e.g., production tubing or casing) corrosion, it is good practice to periodically assess the integrity of the pipes to determine places where intervention is necessary to repair damaged sections.

Pipe inspection is commonly accomplished with electromagnetic techniques based on either magnetic flux leakage (MFL) or eddy currents (EC). While MFL techniques tend to be more suitable for single-pipe inspections, EC techniques allow for the characterization of multiple nested pipes. Eddy-current techniques can be divided into frequency-domain EC techniques and time-domain EC techniques. In frequency-domain EC techniques, a transmitter coil is fed by a continuous sinusoidal signal, producing time-variable primacy fields that illuminate the pipes. The primary fields induce eddy currents in the pipes. These eddy currents, in turn, produce secondary fields that are sensed along with the primary fields in one or more receiver coils placed at a distance from the transmitter coil. Characterization of the pipes is performed by measuring and processing these fields. In time-domain EC techniques, the transmitter is fed by a pulse, producing transient primary fields, which, in turn, induce eddy currents in the pipes. The eddy currents then produce secondary magnetic fields, which can be measured by either a separate receiver coil placed further away from the transmitter, a separate receiver coil co-located with the transmitter, or the same coil as was used as the transmitter.

In frequency-domain EC pipe inspection, when the frequency of the excitation is adjusted so that multiple reflections in the wall of the pipe are insignificant and the spacing between the transmitter and receiver coils is large enough that the contribution to the mutual impedance from the dominant (but evanescent) waveguide mode is small compared to the contribution to the mutual impedance from the branch cut component (associated with the branch point singularity of the Fourier transform of the magnetic vector potential), the remote-field eddy current (RFEC) effect can be observed. In the RFEC regime, the mutual impedance between the transmitter coil and the receiver coil is very sensitive to the thickness of the pipe wall. More specifically, the phase of the impedance varies approximately linearly with the pipe thickness, providing, at least in principle, for a straightforward calculation of the pipe thickness based on a measurement of the phase of the mutual impedance. In practice, however, the linear relationship does not always hold, limiting the accuracy of such a calculation.

### BRIEF DESCRIPTION OF THE DRAWINGS

FIG. 1 is a schematic diagram of an electromagnetic pipe inspection system deployed in an example borehole environment, in accordance with various embodiments.

FIG. 2 is a schematic diagram of an example configuration of an eddy-current logging tool with a receiver and a transmitter placed interior to a set of four nested pipes, in accordance with various embodiments.

FIGS. 3A-3C are graphs of the phase of the mutual impedance as a function of total pipe thickness at frequencies of 1 Hz, 4 Hz, and 8 Hz, respectively, as obtained for the configuration of FIG. 2 based on a linear phase-thickness relationship as well as by simulation in accordance with various embodiments.

FIG. 4 is a graph showing the difference between the phase of the mutual impedance measurable for the pipes and the phase of the mutual impedance measurable for the nominal section as a function of the change in total thickness of the pipes relative to the nominal total thickness, as obtained at 1 Hz for the configuration of FIG. 2, in accordance with various embodiments.

FIG. 5 is a flow chart of a method for the RFEC-based determination of total pipe thickness using a simulated functional relationship between the phase of the mutual impedance and the total pipe thickness, in accordance with various embodiments.

FIG. 6 is a graph of the phase of the mutual impedance as a function of total pipe thickness simulated at 1 Hz for the configuration of FIG. 2, approximated by a piecewise linear function, in accordance with various embodiments.

FIG. 7 is a schematic diagram of an example configuration of an eddy-current logging tool with three receivers placed at different distances from the transmitter, the tool placed interior to a set of four nested pipes, in accordance with various embodiments.

FIG. 8 is a graph of the phase of the mutual impedance as a function of total pipe thickness as obtained based on a linear phase-thickness relationship as well as by simulation, in accordance with various embodiments, for the three receivers of the tool configuration shown in FIG. 7.

FIG. 9 is a graph of example weighting coefficients used to combine measurements across multiple receivers, in accordance with one embodiment.

FIG. 10 is a graph of the phase of the mutual impedance as a function of total pipe thickness as obtained for two different values of the magnetic permeability of the pipes based on a linear phase-thickness relationship as well as by simulation, in accordance with various embodiments.

FIG. 11 is a graph of the phase of the mutual impedance as a function of total pipe thickness as obtained, in accordance with various embodiments, for two different sets of magnetic permeabilities of the pipes that have, however, the same average permeability.

FIG. 12 is a schematic diagram of an optimization routine for calibrating magnetic permeabilities and compensating for phase and/or magnitude mismatches between measured and simulated signals, in accordance with various embodiments.

FIG. 13 is a flow chart of a method for the RFEC-based determination of total pipe thickness that involves calibrating pipe permeabilities and phase compensation factors, in accordance with various embodiments.

FIG. 14 is a block diagram of an example processing facility for the RFEC-based pipe thickness determination, in accordance with various embodiments.

FIGS. 15A-15C are graphs of the true total-thickness variation for a defective region as a function of axial position along the pipes and the total-thickness variation as estimated from measured and simulated phase differences between defective and nominal sections based on a simulated functional relationship between phase difference and total-thickness change obtained using three different respective pipe permeabilities, in accordance with various embodiments.

### DETAILED DESCRIPTION

Described herein are various approaches to RFEC-based pipe inspection that increase the accuracy of pipe-thickness determinations, especially for sets of multiple nested pipes. In general, pipe-thickness determinations in accordance herewith are based on measurements of the mutual phase of the impedance between the transmitter and the receiver of an eddy-current logging tool disposed interior to a set of one or more pipes, in conjunction with a simulated functional relationship, computed using a computational model of the set of pipes, between the phase of the mutual impedance measurable for the pipes and the total (i.e., overall) thickness of the pipes. The simulated functional phase-thickness relationship can deviate from a linear relationship and is generally more accurate, providing for higher accuracy in the inversion of the measured phase for the pipe thickness than a simple linear analytic expression affords. In order to avoid the need to simulate the phase for each value of the thickness that may be encountered during a measurement, the phase-thickness relationship may be approximated, in accordance with various embodiments, by a piecewise linear function obtained by interpolation between, or a polynomial function obtained by fitting to, a finite set of simulated phase values for corresponding thickness values.

In some embodiment, the accuracy of the phase determination is further increased by combining phase measurements taken, and corresponding phase-thickness relationships simulated, at multiple frequencies and/or for multiple receivers placed at multiple different distances from the transmitter, with weighting coefficients that may depend on the frequency and/or the distance between transmitter and receiver, and optionally further on one or more parameters of the set of pipes (e.g., the number of the pipes, the diameters and/or nominal total thickness of the pipes, and/or the magnetic permeabilities and/or electrical conductivities of the pipes). The combination may be accomplished by averaging over multiple values of the pipe thickness determined separately for multiple respective frequencies and/receivers, or by minimizing a cost function aggregating the deviation between measured and simulated phases across the multiple frequencies or the multiple receivers.

In accordance with some embodiments, the pipe thickness of a potentially defective pipe section to be tested, rather than being determined in absolute terms based on an absolute measured phase of the mutual impedance between transmitter and receiver, is computed relative to the (known) pipe thickness of a nominal, non-defective pipe section based on a change in the measured phase of the mutual impedance relative to the phase of the mutual impedance measured for the nominal section. Beneficially, such difference measurements obviate the need to calibrate for any mismatch between the measured and simulated phases for the nominal pipe sections. In addition, phase differences tend to be less sensitive to the magnetic permeability of the pipes than absolute phases, allowing a coarser estimate of the magnetic permeability to be used in the inversion without significant loss in the accuracy of the pipe thickness determination.

The foregoing will be more readily understood from the following detailed description of various embodiment, in particular, when taken in conjunction with the accompanying drawings.

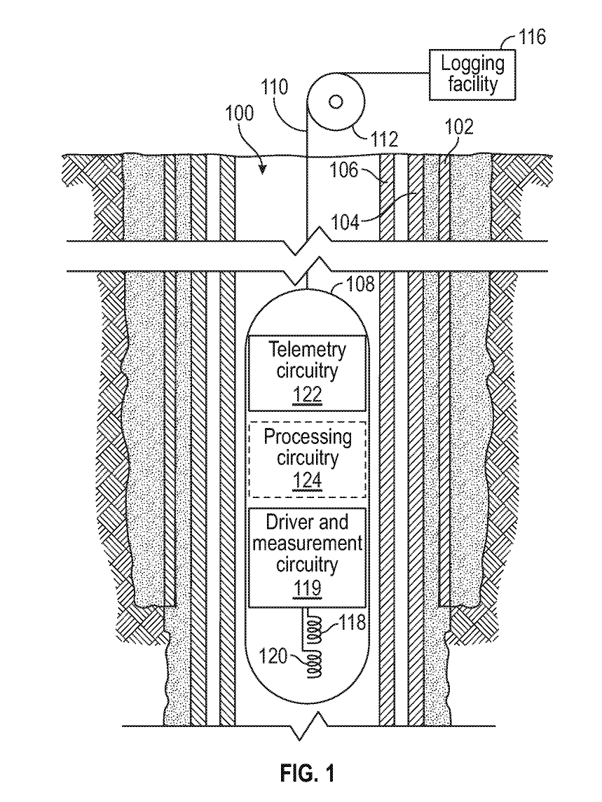

FIG. 1 is a diagram of an electromagnetic pipe inspection system deployed in an example borehole environment, in accordance with various embodiments. The borehole 100 is shown during a wireline logging operation, which is carried out after drilling has been completed and the drill string has been pulled out. As depicted, the borehole 100 has been completed with surface casing 102 and intermediate casing 104, both cemented in place. Further, a production pipe 106 has been installed in the borehole 100. While three pipes 102, 104, 106 are shown in this example, the number of nested pipes may generally vary, depending, e.g., on the depth of the borehole 100. As a result, the total thickness of the pipes may also vary as a function of depth.

Wireline logging generally involves measuring physical parameters of the borehole 100 and/or surrounding formation—such as, in the instant case, the condition of the pipes 102, 104, 106—as a function of depth within the borehole 100. The pipe measurements may be made by lowering an electromagnetic logging tool 108 into the wellbore 100, for instance, on a wireline 110 wound around a winch 112 mounted on a logging truck. The wireline 110 is an electrical cable that, in addition to delivering the tool 108 downhole, may serve to provide power to the tool 108 and transmit control signals and/or data between the tool 108 and a logging facility 116 (implemented, e.g., with a suitably programmed general-purpose computer including one or more processors and memory) located above surface, e.g., inside the logging truck. In some embodiments, the tool 108 is lowered to the bottom of the region of interest and subsequently pulled upward, e.g., at substantially constant speed. During this upward trip, the tool 108 may perform measurements on the pipes, either at discrete positions at which the tool 108 halts, or continuously as the pipes pass by.

In accordance with various embodiments, the electromagnetic logging tool 108 used for pipe inspection is a frequency-domain eddy-current tool configured to generate, as the electromagnetic excitation signal, an alternating primary field that induces eddy currents inside the metallic pipes, and to record, as the electromagnetic response signal, secondary fields generated from the pipes; these secondary fields bear information about the electrical properties and metal content of the pipes, and can be inverted for any corrosion or less in metal content of the pipes. The tool 108 generally includes one or more transmitters (e.g., transmitter coil 118) that transmit the excitation signals and one or more receivers (e.g., receiver coil 120) to capture the response signals. The transmitter and receiver coils 118, 120 are spaced apart along the axis of the tool 108 and, thus, located at slightly different depths within the borehole 100; the transmitter-receiver distance may be, e.g., in the range from 20 inches to 80 inches. The tool may be configured to operate at multiple frequencies, e.g., between about 0.5 Hz and about 4 Hz. The tool 108 further includes, associated with the transmitter(s) and receiver(s), driver and measurement circuitry 119 configured to operate the tool 108 at the selected frequency.

The tool 108 may further include telemetry circuitry 122 for transmitting information about the measured electromagnetic response signals to the logging facility 116 for processing and/or storage thereat, or memory (not shown) for storing this information downhole for subsequent data retrieval once the tool 108 has been brought back to the surface. Optionally, the tool 108 may contain analog or digital processing circuitry 124 (e.g., an embedded microcontroller executing suitable software) that allows the measured response signals to be processed at least partially downhole (e.g., prior to transmission to the surface). From a sequence of measurements correlated with the depths along the borehole 100 at which they are taken, a log of the pipe thickness can be generated. The computer or other circuitry used to process the electromagnetic excitation and response signals to compute the phase of the mutual impedance between transmitter and receiver and derive the total pipe thickness based thereon is hereinafter referred to as the processing facility, regardless whether it is contained within the tool 108 as processing circuitry 124, provided in a separate device such as logging facility 116, or both in part. Collectively, the electromagnetic logging tool 108 and processing facility (e.g., 124 and/or 116) are herein referred to as a pipe inspection system.

Alternatively to being conveyed downhole on a wireline, as described above, the electromagnetic logging tool 108 can be deployed using other types of conveyance, as will be readily appreciated by those of ordinary skill in the art. For example, the tool 108 may be lowered into the borehole 100 by slickline (a solid mechanical wire that generally does not enable power and signal transmission), and may include a battery or other independent power supply as well as memory to store the measurements until the tool 108 has been brought back up to the surface and the data retrieved. Alternative means of conveyance include, for example, coiled tubing or downhole tractor.

In accordance with RFEC techniques as described herein, the electromagnetic excitation and response signals are processed to determine the mutual impedance between transmitter and receiver coils. From the phase of the mutual impedance, the total thickness of the pipes (that is, the sum of the thicknesses of all nested pipes) can be computed. Conventionally, for a fast inversion process, the variation of the phase co of the mutual impedance as a function of total pipe thickness is approximated by a linear expression:

φ=2\sqrt{ωμσ/2}t,

where ω is the angular frequency of the excitation, μ is the magnetic permeability of the pipe(s), σ is the electrical conductivity of the pipe(s), and t is the total thickness of the pipe(s). The magnitude of the impedance shows the dependence:

exp[−2\sqrt{ωμσ/2}t].

With the common definition of the skin depth for the metals,

δ=\sqrt{2/(ωμσ)},

the phase of the impedance varies as:

φ=2t/δ,

and the magnitude of the impedance shows the dependence:

exp[−2t/δ].

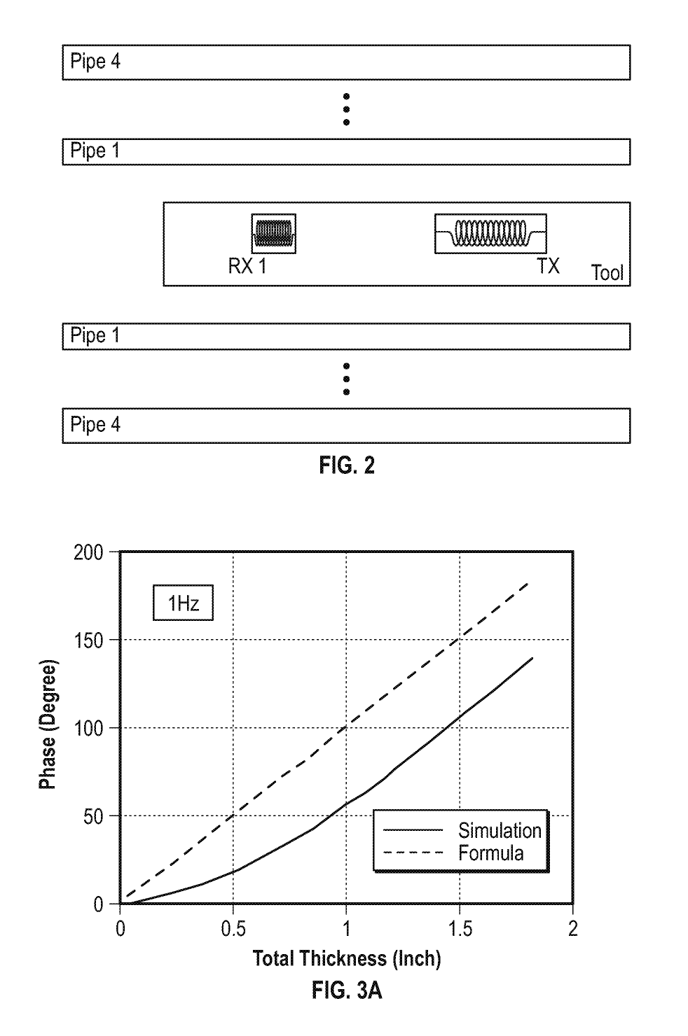

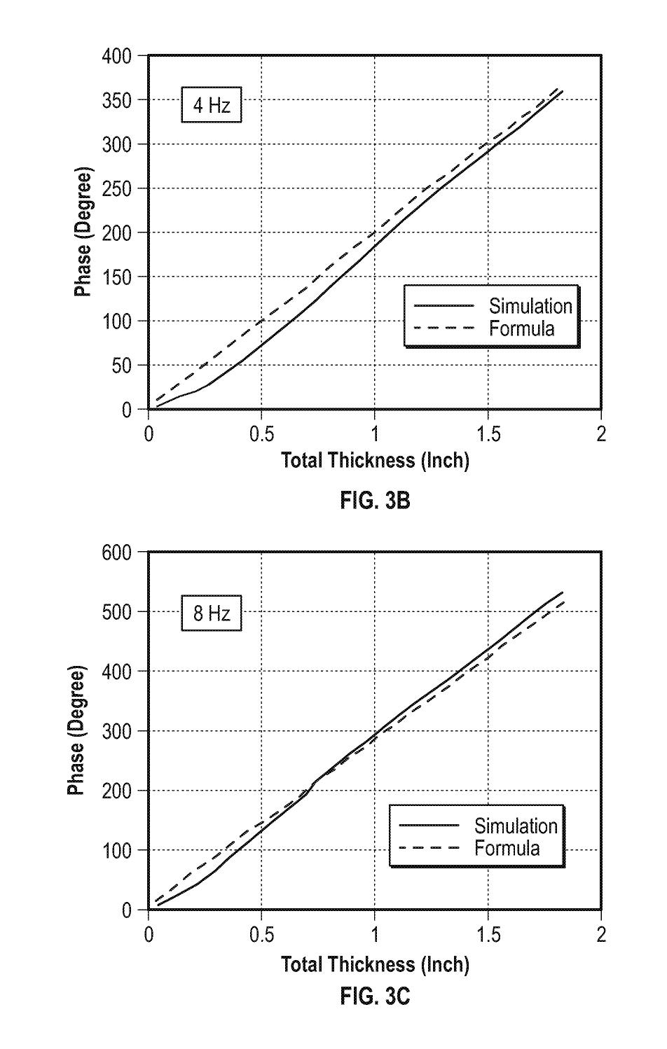

The above linear phase-thickness relationship does not represent the behavior of the phase variation versus total thickness accurately under all circumstances, and can be erroneous, in particular, for large total pipe thickness. This is illustrated in FIGS. 2 and 3A-3C. FIG. 2 shows an example configuration of an eddy-current logging tool with a receiver RX1 and a transmitter TX placed interior to a set of four nested pipes with outer diameters (OD) of 5 inches, 9+⅝ inches, 13+⅜ inches, and 18+⅝ inches, respectively. The dimensions of the transmitter and receiver coils and the distance between them are summarized in Table 1.

TABLE 1

| | | | | Distance |
|---|---|---|---|---|
| | OD | Number | Length | from TX |
| Coil | (inches) | of Turns | (inches) | (inches) |
| TX | 1.28 | 5200 | 16 | 0 |
| RX1 | 0.978 | 27000 | 12 | 62 |

The thickness of the pipes is modeled to vary from 0.01 inches to 0.46 inches for each pipe in a way such that all pipes have the same thickness at any axial location, resulting in a total-thickness variation of the pipes from 0.04 inches to 1.84 inches.

FIGS. 3A-3C show the phase of the mutual impedance as a function of total pipe thickness across a range from 0 inches to 1.84 inches at frequencies of 1 Hz, 4 Hz, and 8 Hz, respectively, as obtained for the configuration of FIG. 2 both by simulation and based on the linear phase-thickness relationship. As can be observed, the linear relationship does not match the simulation result very well at lower frequencies. The match becomes better at higher frequencies, for example, at 5 Hz. However, in practice, it is usually not possible to measure responses of four pipes with good accuracy at this frequency, as the attenuation that the electromagnetic response signal originating at the outer pipes experiences when passing though the inner pipes is more significant at higher frequencies. In order to accurately measure a change in the thickness of the outer pipes, it is therefore generally desirable to improve the accuracy of the thickness determination for low frequencies beyond that achieved with the linear relationship.

While illustrating a significant deviation of the simulated phase-thickness relationship from a linear functional relationship, FIGS. 3A-3C also show that the slope of the simulated and linear relationships are similar for large values of the total thickness (and, accordingly, large phase values). For example, from FIG. 3A, it is observed that the two curves are approximately parallel for total thicknesses above 1 inch (corresponding to phases above about 55 degrees). This implies that, for total thicknesses beyond 1 inch (or some other thickness threshold for other pipe configurations), the above-mentioned linear relationship may provide a suitable approximation for estimating the change in pipe thickness of a defective section relative to the nominal thickness (the change usually being a reduction in pipe thickness due to corrosion) from the difference between the phases measured for the defective and non-defective (or “nominal”) sections:

$${t}_{d} - {t}_{n} = \frac{δ}{2} ( {ϕ}_{d} - {ϕ}_{n} ) ,$$

where t_{d} is the total thickness of the pipes in the defective section, which is to be estimated, tₙ is the known total thickness of the pipes in the non-defective sections, and φ_{d} and φₙ are the corresponding phases measured in the defective and non-defective sections. This relationship is hereinafter also referred to as the “differential linear relationship.” Since the slope δ/2 depends, via the skin depth, on the magnetic permeability of the pipes, the use of the linear phase-thickness relationship under the RFEC assumptions for fast inversion is generally preceded by an estimation of the magnetic permeability.

In accordance with various embodiments, the accuracy of RFEC-based pipe thickness determinations is improved by employing simulations to more accurately predict the change of the phase of the mutual impedance with variations in total pipe thickness, thereby rendering the method workable for any value of the total pipe thickness or change in total pipe thickness. The simulations are specific to the pipe configuration and are, for a given configuration, based on a computational model of the pipes that specifies the pipe dimensions and material parameters. In order to obtain the pipe-thickness dependency of the phase of the mutual impedance, simulations are carried out for multiple values of the total pipe thickness, e.g., spanning a range from the nominal total pipe thickness to the smallest total pipe thickness, which corresponds to the greatest defect in thickness. The simulations can be implemented with various analytical or numerical approaches known in the art. A suitable analytic approach is described, for example, in S. M. Haugland, “Fundamental analysis of the remote-field eddy-current effect,” IEEE Transactions on Magnetics, Vol. 32, No. 4, pp. 3195-3211, 1996 (herein “Haugland”), which examines the mutual impedance between two induction coils placed inside a long metal (ferrous or nonferrous) pipe, as well as placed inside the innermost of two metal pipes. The technique involves decomposing the mutual impedance into terms that represent waveguide modes and radiation modes, and comparing the separately computed terms associated with the radiation modes to the total mutual impedance. As is shown, RFEC measurements can be made when the radiation term is dominant, which implies the linear variation of the phase of mutual impedance with the overall thickness of the pipes. The simulation results presented in the present disclosure were obtained using the technique described in Haugland. Suitable numerical approaches include, e.g., finite element methods (FEM) and finite difference time domain (FDTD) methods, etc. In some embodiments, the simulations are performed during the characterization process for a given set of pipes under test. In other embodiments, simulations are pre-computed and stored in memory for, generally, multiple possible pipe configurations, and during the subsequent characterization of a particular set of pipes, the phase-thickness relationship simulated for the corresponding pipe configuration (if available), or the phase-thickness relationship simulated for the best-matching pipe configuration (if sufficiently close to the actual configuration) is selected for processing the phase measurements.

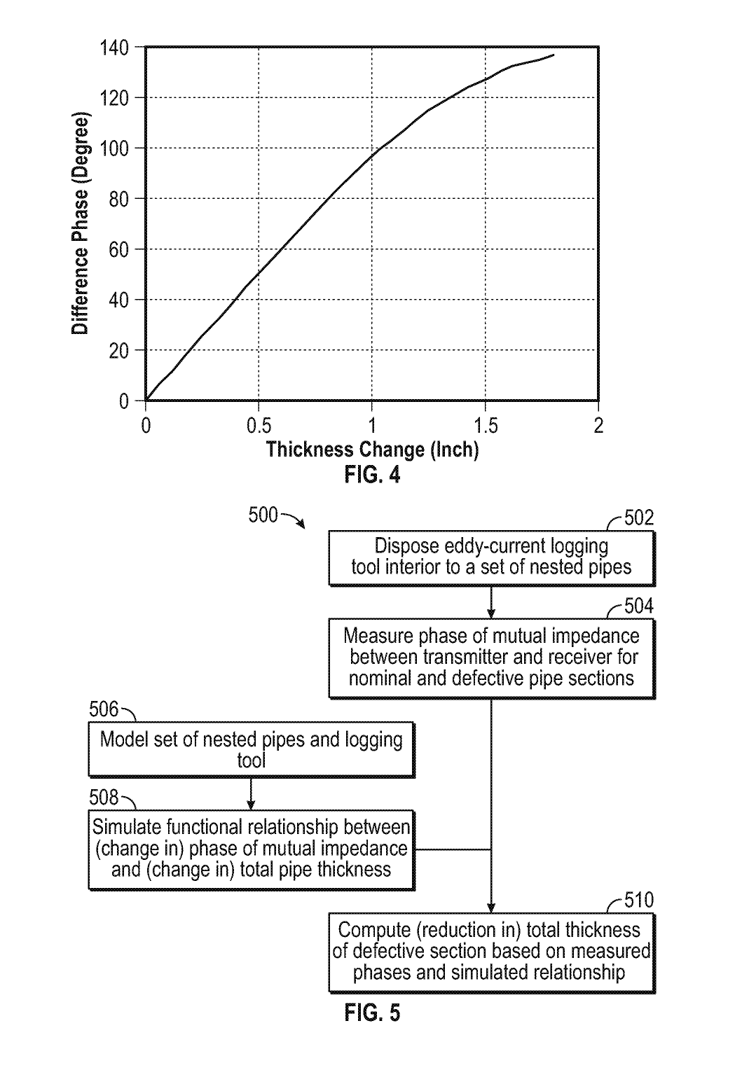

In various embodiments described herein, pipe-thickness determinations are based on the functional relationship between the absolute phase of the mutual impedance and the absolute total thickness of the pipes. In this approach, the simulated absolute phase for a nominal pipe section (i.e., a pipe section having nominal total thickness) may differ from the measured absolute phase for the nominal pipe section (though the difference is usually smaller than that between the measured phase and the phase as computed from the above-referenced linear relationship), calling for phase-compensation value to correct for the mismatch, as explained in more detail further below. In various alternative embodiments, pipe-thickness determinations are based on the functional relationship between a “difference phase” corresponding to the phase of the mutual impedance for a given pipe section relative to the phase for a nominal pipe section and a change in total pipe thickness relative to the nominal thickness. FIG. 4 illustrates the variation of the difference phase versus change in total thickness for the same pipe configuration for which the absolute phase variation is shown in FIG. 3A. The nominal thickness of 1.84 inches in FIG. 3A maps onto a change in total thickness of zero. In this difference-based approach, any mismatch between the measured and simulated phases for the nominal pipe section inherently cancels out, obviating the need for phase-compensation values. Various optional features of the approaches described herein, such as approximations of the phase-thickness relationship by piecewise linear or polynomial functions, or the combination of measurements and simulations across multiple frequencies or receivers, are illustrated herein below for absolute-phase/absolute-thickness relationships, but can be straightforwardly applied, by those of ordinary skill in the art, to functional relationships between the difference phase and change in total thickness as well (hereinafter also called “differential (simulated) phase-thickness relationship”.

FIG. 5 is a flow chart providing an overview of a method 500 for the RFEC-based determination of total pipe thickness in accordance with various embodiments. The method 500 involves disposing an eddy-current logging tool interior to a set of pipes (e.g., a single pipe or a set of nested pipes) (act 502), and measuring the phase of the mutual impedance between the transmitter and a receiver of the tool for nominal and defective pipe sections (act 504). Further, in preparation for processing the measured phases, the logging tool and the set of nested pipes are modeled (in act 506) to simulate a functional relationship between the (absolute) phase of the mutual impedance and the total pipe thickness, or a differential functional relationship between a difference phase (corresponding to the change in phase relative to the phase measured for the nominal section) and the change in total pipe thickness relative to the nominal total pipe thickness (act 508). In the model underlying the simulation, the pipes may be assumed to all have the same thickness, i.e., the thickness of each individual pipe may be modeled as the total thickness of all pipes divided by the number of pipes. Further, as described in detail below, the (absolute or differential) functional relationship may be an approximate relationship taking the form, e.g., of a piecewise linear or polynomial function. From the measured phases for defective pipe sections (taken absolutely or as difference phases relative to the phase for the nominal section) in conjunction with the (absolute or differential) functional relationship, corresponding values of the total thickness of the defective pipe sections, or reductions in the total thickness relative to the normal sections, are computed (act 510). In some embodiments, phase measurements are taken (in act 504) and functional relationships are simulated (in act 508), for multiple receivers of the tool and/or multiple frequencies of the electromagnetic signals, and the total thickness is computed (in act 510) based on a combination of measurements and simulations across the multiple receivers and/or frequencies.

Employing a simulated phase-thickness relationship in lieu of the simple linear relation φ=2t/δ can significantly improve the accuracy of pipe-thickness determinations, especially for large changes in the total pipe thickness (corresponding to small total pipe thicknesses), but can come at the cost of performing a large number of computationally expensive simulations. In order to reduce the number of simulations while retaining most of the benefit of using a simulated functional relationship, an approximate simulated relationship is obtained in various embodiments. The true variation of the phase versus total pipe thickness, as can be described with high accuracy if simulations are performed for virtually all possible values of the total thickness (that is, to obtain a high resolution in total thickness) can be approximated, for instance, by a piecewise linear function. The number of linear segments depends on the desired accuracy of the approximation.

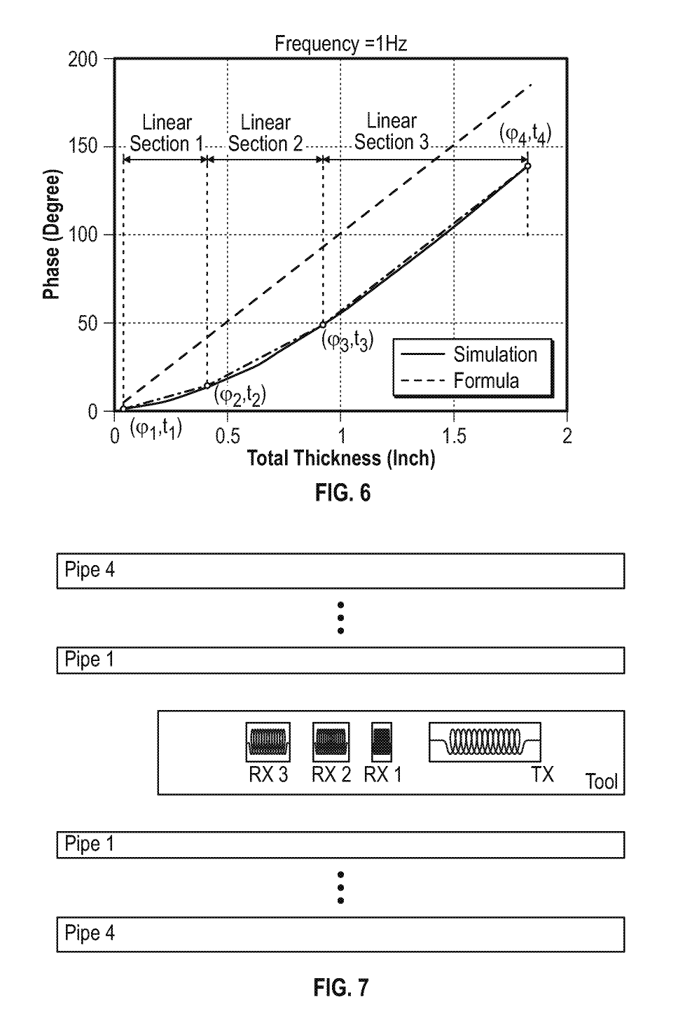

FIG. 6 is a graph of the phase variation with total pipe thickness shown in FIG. 3A, approximated by a piecewise linear function, in accordance with various embodiments. In the example shown, the piecewise linear function includes three linear segments: a first straight line between points (φ₁, t₁) and (φ₂, t₂), a second straight line between points (φ₂, t₂) and (φ₃, t₃), and a third straight line between points (φ₃ t₃) and (φ₄, t₄). The values of the phases φ₁, φ₂, φ₃, and φ₄, can be obtained from simulations (based on a model for the pipe configuration shown in FIG. 2) for total pipe thicknesses of t₁, t₂, t₃, and t₄, respectively. If, as shown, t₁ is zero, φ₁ can be approximated with zero as well, without a need for simulating this point. Having these linear segments stored in memory for the corresponding set of test pipes, the proper linear segment to be employed in inverting a measured phase for the total thickness can be selected.

In a general scheme, M linear segments may be employed to approximate the variation of the phase versus total thickness for a given tool and set of pipes. To obtain the M segments, M+1 simulations are performed at total thicknesses of t₁ to t_{M+1} to obtain phase values φ₁ to φ_{M+1}, where t_{M+1} and φ_{M+1} are the total thickness and measured phase corresponding to the non-defective (nominal) sections of the pipes. Then, if a measured phase φ_{d} for a defective pipe section is within the m-th linear segment (1≤m≤M), i.e., φₘ≤φ_{d}≤φₘ₊₁, the corresponding estimated total thickness t_{d} can be computed from:

$${t}_{d} = \frac{1}{S} ( {ϕ}_{d} - {ϕ}_{m + 1} ) + {t}_{m + 1}$$

where s is the slope of the line established between points (φₘ, tₘ) and (φₘ₊₁, tₘ₊₁).

In this embodiment, the number of linear segments used to approximate the true phase variation versus total thickness can be determined based on the anticipated magnitude of phase changes occurring between the non-defective and defective sections of the pipes, i.e., the maximum expected value for |φ_{d}−φₙ|. For smaller changes in total thickness, a smaller number of linear segments between points (φ_{d}, t_{d}) and (φₙ, tₙ) suffices, leading to fewer simulations, and thus faster characterization of the pipes if defective regions with approximately similar thickness variations are being evaluated.

In general, the proposed RFEC inversion approach, despite employing simulations, is still faster than performing a standard optimization-based inversion technique since the number of simulations to establish the linear segments is typically much smaller than the number of forward-model simulations used to solve a typical optimization problem.

As an alternative to approximating the true phase variation versus total thickness by a piecewise linear function, a polynomial curve may be fit to a set of simulated points (φₘ, tₘ), approximating the phase-thickness variation t in the form of:

t=a_{N}φ^{N}+a_{N-1}φ^{N-1}+ . . . +φa₁+a₀,

where coefficients aₙ, n=0, . . . , N are found such that the difference between the simulated tₘ values and the total thicknesses computed with the above polynomial when plugging in the corresponding φₘ values is minimized. To provide N+1 equations for determining the N+1 coefficients, N+1 simulations may be performed; for example, a second-order polynomial can be fitted to three points (φₘ, tₘ). In addition to simulating the phase for the nominal pipe thickness, the phase may be simulated for N (or more) defective pipe sections with various total thicknesses. Once the polynomial coefficients have been determined, the total pipe thickness t_{d} for any defected region can be computed from a phase φ_{d}, measured for that region by evaluating the above equation for φ=φ_{d}. As will be readily appreciated by those of ordinary skill in the art, the described approximation approaches can be generalized to also include approximations of the true functional relationship between phase and total thickness by a piecewise polynomial function.

While the approximation of the true phase-thickness relationship has been illustrated for the absolute phase as a function of absolute thickness, the approach can be modified straightforwardly to approximate the functional relationship between a difference phase and a change in total thickness relative to the nominal thickness as shown, e.g., in FIG. 4.

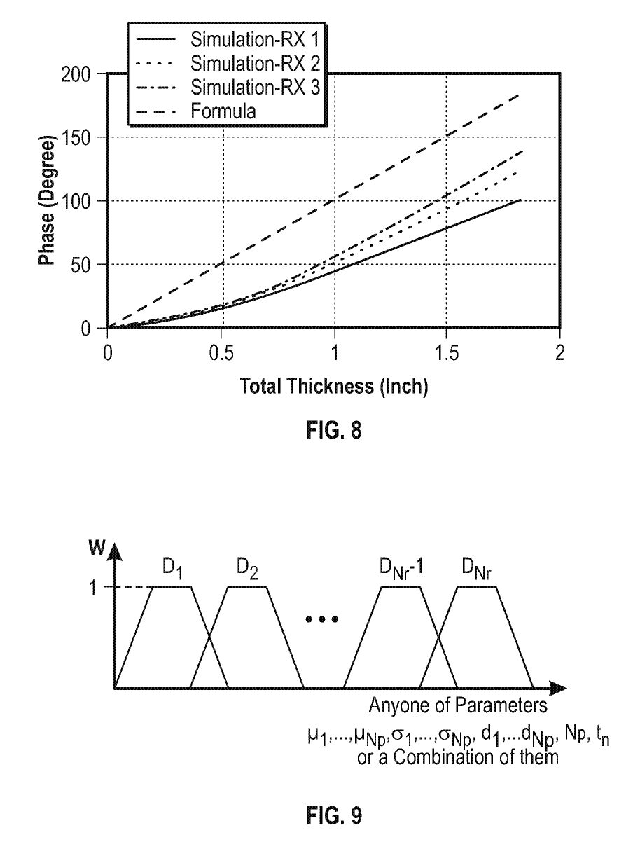

As is well-known in UK inspection, longer distances between the transmitter and the receiver provide better linear regimes for the variation of the phase of the mutual impedance with respect to the total thickness of the pipes. This is illustrated in FIGS. 7 and 8. FIG. 7 shows an example configuration of an eddy-current logging tool with a transmitter TX and three receivers RX1, RX2, RX3 placed interior to a set of four nested pipes with the same outer diameters and thickness change as discussed previously with reference to the configuration shown in FIG. 2 (i.e., outer diameters of 5 inches, 9+⅝ inches, 13+⅜ inches, and 18+⅝ inches; and thicknesses varying for each of the four pipes from 0.01 inches to 0.46 inches, such that the total pipe thickness changes from 0.04 inches to 1.84 inches). The dimensions of the transmitter and receiver coils and the distances between them are summarized in Table 2.

TABLE 2

| | | | | Distance |
|---|---|---|---|---|
| | OD | Number | Length | from TX |
| Coil | (inches) | of turns | (inches) | (inches) |
| TX | 1.28 | 5200 | 16 | 0 |
| RX1 | 0.97 | 17700 | 8 | 40 |
| RX2 | 0.97 | 17700 | 8 | 50 |
| RX3 | 0.97 | 27700 | 12 | 6.2 |

FIG. 8 compares the phase variation as a function of total pipe thickness for the three receivers RX1, RX2, and RX3. The linear phase variation ω=2t/δ is also shown. As is observed from FIG. 8, for all three receivers, the phase dependence on total thickness is non-linear for lower values of the total thickness and becomes increasingly linear for increasing total thickness values. For the receiver RX3, which, at a distance of 62 inches, is farthest from the transmitter TX, the slope of the quasi-linear phase variation is closest, among the three receivers, to that of the analytic expression φ=2t/δ, rendering the latter a better approximation for small thicknesses than the phase variation for receivers RX1 and RX2. This implies that, in general, the RFEC assumption of linear variation of the phase with the total thickness is more accurate for longer transmitter-receiver distances. However, in practice, the extent to which the transmitter-receiver distance can be increased is limited. One constraint is that, for the purpose of logging, the logging tool cannot be extremely long. Another constraint is that the response to excitation of the pipes measured at the receiver is weaker for greater distances of the receiver from the transmitter. Thus, practically, the transmitter-receiver distances cannot be increased without considering these limitations.

In accordance with various embodiments, measurements of the phase of the mutual impedance between transmitter and receiver are combined across multiple receivers placed at various distances from the transmitter (e.g., as shown for three receivers in FIG. 7) to improve the tradeoff between the accuracy of the RFEC-based thickness determination, which tends to be greater for greater transmitter-receiver distances, and the reliability of the measurement of the response signal, which is generally better for smaller transmitter-receiver distances. Furthermore, measurements can be performed at multiple frequencies to provide more information for a more reliable inversion. When combining the processing of measurements taken by multiple receivers and/or at multiple frequencies, the simulated functional relationship between phase and total thickness can be determined separately for each receiver-frequency combination, using any of the above-described approaches. For example, to implement the approximation of the phase-thickness relationship by a piecewise linear function, points (tₘ(i,j),φₘ(i,j)) can be simulated for each combination of a receiver RXᵢ (i=1, . . . , Nᵣ) and a frequency fⱼ (j=1, . . . , N_{f}), and linear segments with slopes s(i,j) can be created by interpolation between these points. Similarly, when using a polynomial approximation, polynomial coefficients aₙ(i,j) (n=0, . . . , N) can be derived for each receiver RXᵢ and each frequency fⱼ. In simulating the points (tₘ(i,j),φₘ(i,j)), the thicknesses tₘ(i,j) may (but need not) be chosen to be the same for all pairs (i,j) but the simulated phases will nonetheless generally differ between the various receiver-frequency combinations.

To obtain a single total thickness estimation from the measurements and simulations for the multiple receivers and/or frequencies, either multiple total-thickness estimates determined individually for each receiver-frequency combination, or the processing of the various responses measured by different receivers and/or at different frequencies, can be combined properly, as illustrated in the following with the example of piecewise linear approximations of the phase-thickness relationship.

Considering first separate total-thickness estimates for the various receiver-frequency combinations, assume that phase φ_{d}(i,j) measured for receiver RXᵢ and frequency fⱼ falls in the m-th linear segment of the simulated relationship for (i,j), that is, between the points (t_{m(i,j)}(i,j),φ_{m(i,j)}(i,j)) and (tₘ₊₁(i,j),φ_{m(i,j)+1}(i,j)). (Note that, here, the applicable index in, itself is a function of the receiver and frequency.) The individual total-thickness estimates t_{d}(i,j) can then be determined from the following set of equations, each solved separately:

$$\{ \begin{matrix}{ϕ}_{d} ( 1 , 1 ) - {ϕ}_{m ( 1 , 1 ) + 1} ( 1 , 1 ) = s ( 1 , 1 ) ( {t}_{d} ( 1 , 1 ) - {t}_{m ( 1 , 1 ) + 1} ( 1 , 1 ) ) \\ ⋮ \\ {ϕ}_{d} ( i , j ) - {ϕ}_{m ( i , j ) + 1} ( i , j ) = s ( i , j ) ( {t}_{d} ( i , j ) - {t}_{m ( i , j ) + 1} ( i , j ) ) \\ ⋮ \\ {ϕ}_{d} ( {N}_{r} , {N}_{f} ) - {ϕ}_{m ( {N}_{r} , {N}_{f} ) + 1} ( {N}_{r} , {N}_{f} ) = s ( {N}_{r} , {N}_{f} ) ( {t}_{d} ( {N}_{r} , {N}_{f} ) - \\ {t}_{m ( {N}_{r} , {N}_{f} ) + 1} ( {N}_{r} , {N}_{f} ) )\end{matrix}$$

From the individual total-thickness estimates t_{d}(i,j), a single final total thickness estimate t_{d}^{f} can be obtained by simply averaging over the Nᵣ receivers and the N_{f} frequencies:

$${t}_{d}^{f} = \frac{{\sum }_{i = 1}^{{N}_{r}} {\sum }_{j = 1}^{{N}_{f}} {t}_{d} ( i , j ) }{{N}_{r} {N}_{f}} .$$

In some embodiments, the individual total-thickness estimates t_{d}(i,j) are combined in a weighted manner, with weighting coefficients w(i,j) that generally depend on the receiver and frequency:

t_{d}^{f}=Σᵢ₌₁^{N}^{ᵣ}Σⱼ₌₁^{N}^{_{f}}w(i,j)t_{d}(i,j).

One possible way of choosing the weighting coefficients is such that the contribution of the results obtained from receivers at longer distances from the transmitter or from measurements implemented at lower frequencies is larger. In a more general scheme, the weighting coefficients w(i,j) may be a function of the distance Dᵢ of the respective receiver from the transmitter, the frequency of operation fⱼ, the number of inspected pipes Nₚ, the magnetic permeabilities μ₁ to μ_{Np} and electrical conductivities σ₁ to ν_{Np} of the pipes, the diameters d₁ to d_{Np} of the pipes, and the nominal total thickness tₙ of the pipes. Thus, in general, the weighting coefficients can be denoted as w(Dᵢ, fⱼ, μ₁, . . . , μ_{Np}, σ₁, . . . , σ_{Np}, d₁, . . . , d_{Np}, Nₚ, tₙ). The weighting coefficients may be constrained to SUM up to 1 for all the receivers and all the measurement frequencies:

Σᵢ₌₁^{N}^{ᵣ}Σⱼ₌₁^{N}^{_{f}}w(Dᵢ,fⱼ,μ₁, . . . ,μ_{Np},σ₁, . . . ,σ_{Np},d₁, . . . ,d_{Np},Nₚ,tₙ)=1.

FIG. 9 illustrates one possible choice of the weighting coefficients for a single frequency. Herein, the values along the horizontal axis can be any one or a function of the parameters μ₁, . . . , μ_{Np}, σ₁, . . . , σ_{Np}, d₁, . . . , d_{Np}Nₚ, and tₙ; for example, the horizontal axis can correspond to values of tₙ/δ, where δ is the skin depth computed using an average permeability of the pipes. In accordance with the weighting coefficients of FIG. 8, the total thickness t_{d}^{f} includes, for each value of the function of parameters reflected by the horizontal axis, contributions from at most two neighboring receivers.

Turning now to the combined processing of phase measurements acquired by multiple receivers and/or at multiple frequencies, a single total thickness t_{d} can be computed by simultaneously solving, e.g., in a least-square sense, the following system of equations:

$$[ \begin{matrix}s ( 1 , 1 ) \\ ⋮ \\ s ( i , j ) \\ ⋮ \\ s ( {N}_{r} , {N}_{f} )\end{matrix} ] {t}_{d} = [ \begin{matrix}{ϕ}_{d} ( 1 , 1 ) - {ϕ}_{m + 1} ( 1 , 1 ) + s ( 1 , 1 ) {t}_{m + 1} ( 1 , 1 ) \\ ⋮ \\ {ϕ}_{d} ( i , j ) - {ϕ}_{m + 1} ( i , j ) + s ( i , j ) {t}_{m + 1} ( i , j ) \\ ⋮ \\ {ϕ}_{d} ( {N}_{r} , {N}_{f} ) - {ϕ}_{m + 1} ( {N}_{r} , {N}_{f} ) + s ( {N}_{r} , {N}_{f} ) {t}_{m + 1} ( {N}_{r} , {N}_{f} )\end{matrix} ]$$

The solution can be obtained by minimizing the cost function:

J(x)=∥y−Ax∥²,

where

$$y = [ \begin{matrix}{ϕ}_{d} ( 1 , 1 ) - {ϕ}_{m + 1} ( 1 , 1 ) + s ( 1 , 1 ) {t}_{m + 1} ( 1 , 1 ) \\ ⋮ \\ {ϕ}_{d} ( i , j ) - {ϕ}_{m + 1} ( i , j ) + s ( i , j ) {t}_{m + 1} ( i , j ) \\ ⋮ \\ {ϕ}_{d} ( {N}_{r} , {N}_{f} ) - {ϕ}_{m + 1} ( {N}_{r} , {N}_{f} ) + s ( {N}_{r} , {N}_{f} ) {t}_{m + 1} ( {N}_{r} , {N}_{f} )\end{matrix} ] '$$

$$A = [ \begin{matrix}s ( 1 , 1 ) \\ ⋮ \\ s ( i , j ) \\ ⋮ \\ s ( {N}_{r} , {N}_{f} )\end{matrix} ] , and x = {t}_{d} .$$

To incorporate weighting coefficients, the cost function may be modified to:

J(x)=∥W(y−Ax)∥²,

where W is a diagonal matrix and its diagonal elements are the weighting coefficients to be applied to the equations for different receiver-frequency combinations.

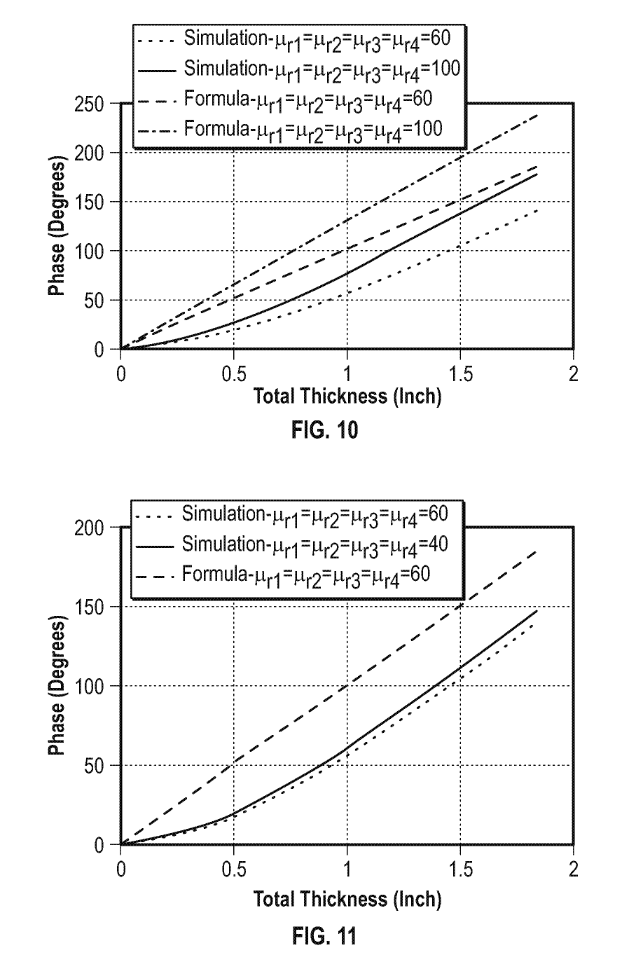

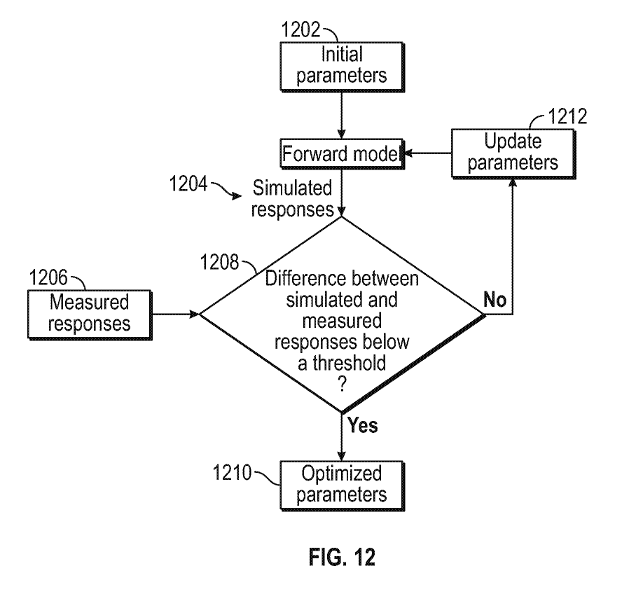

The embodiments described so far rely on knowledge of the relative magnetic permeabilities (μᵣ) of the pipes. Good estimates of the magnetic permeability are important for obtaining accurate results using the RFEC approach. This is illustrated in FIG. 10, which shows the variation of the phase of the simulated mutual impedance versus total thickness for the configuration of FIG. 2 at a frequency of 1 Hz for a magnetic permeability of all pipes of μᵣ=60 in comparison with μᵣ=100. The two curves are significantly different, confirming the importance of a good estimate of μᵣ for RFEC-based thickness determinations in accordance herewith. Such permeability estimates can be obtained by calibration from measurements and simulations for the non-defective section of the pipes using an optimization approach (e.g., as described in more detail below with reference to FIG. 12), and can thereafter be applied to the defective sections.

FIG. 11 compares the variation of the phase of the simulated mutual impedance versus total thickness for the configuration of FIG. 2 for two sets of magnetic permeability: in one set, all pipes have the same relative magnetic permeability of μ₁=μ₂=μ₃=μ₄=60, and in the other set, two pipes have permeability μ₁=μ₂=80 and the other two pipes have permeability μ₃=μ₄=40. It is observed that the phase variation for the first set, in which the permeability is the same for all pipes and is equal to the average permeability of the four pipes in the second set, is close to the phase variation of the second set. Thus, when the pipes have different permeabilities, their average permeability can be employed to obtain the simulated (and optionally approximate) functional relationship (or to compute the slope in the linear relationship

$$( {ϕ}_{d} - {ϕ}_{n} ) = \frac{2}{δ} ( {t}_{d} - {t}_{n} ) \text{)} .$$

The average permeability of the pipes can be optimized for directly, or can be obtained indirectly by averaging over optimized permeabilities obtained for the individual pipes.

In addition to determining magnetic permeabilities, the calibration process may serve to compensate, at least partially, for any mismatch between the measured and simulated phases of the mutual impedance for the nominal pipe section. In accordance with various embodiments, a phase compensation value φ^{c}(i,j) is computed for each receiver RXᵢ and each measurement frequency fⱼ, and is thereafter added to the measured phases φ_{d}^{m}(i,j), or subtracted from the simulated phase φ_{d}^{s}(i,j), for defective sections to compensate for the mismatch, according to:

φ_{d}^{s}(i,j)=φ_{d}^{m}(i,j)+φ^{c}(i,j).

Once determined from the nominal section, the phase compensation values may be used to correct the simulated functional relationship between phase and total thickness prior to using that relationship for total-thickness determinations from measured phases. The phase compensation process may be implemented for some sample pre-known pipes and at the acquisition frequencies, and interpolation can be employed to obtain the phase compensation values for other pipes and frequencies.

FIG. 12 illustrates a general optimization routine for implementing the calibration process to estimate pipe permeabilities and/or phase compensation values, as well as, optionally, calibration coefficients that compensate for any mismatch in magnitude between the measured and simulated mutual impedance. The process employs a forward model 1200 for the computation of the response signal(s) measured at the receiver(s) based on the excitation signal from the transmitter. For a given set of optimizable parameters (discussed further below), initial parameter values 1202 are fed into the forward model 1200 to compute simulated responses 1204 for the nominal pipe sections. The simulated responses 1204 are then compared to measured responses 1206 for the nominal pipe sections, and if a suitable measure 1208 of the difference between the two (the measure being, e.g., the value of a cost function that takes the phases and/or magnitudes of the measured and simulated responses as arguments), falls below a specified threshold, the current parameter values are taken to be the optimized parameters 1210. Otherwise, if the measure 2108 of the difference between measured and simulated responses exceeds the threshold, the parameters are updated, and the forward model is employed to update the simulated responses 1206 based on the updated parameter values 1212. The process is repeated iteratively until convergence between the simulated and measured response is achieved.

In the optimization process, permeability and phase compensation value(s) (and, if applicable, calibration coefficients to match the magnitudes of the measured and simulated mutual impedance) can be estimated simultaneously or sequentially. In one optimization scheme, the optimizable parameters are chosen to be the permeabilities of the pipes (or the average permeability of the pipes) and the calibration coefficients for matching the magnitudes of the impedance. The response parameters used for purposes of the optimization (e.g., as arguments of the cost function) are chosen to be the impedance magnitudes of the measured and simulated signals received at one or more receivers and at one or more frequencies, whose difference is to be minimized. Following optimization of the permeabilities and calibration coefficients, the phase compensation values are then obtained by subtracting the measured phases for the nominal section from the simulated phases for the nominal sections as determined with the optimized parameters:

φ^{c}(i,j)=φₙ^{s}(i,j)−φₙ^{m}(i,j).]

In an alternative optimization scheme, the optimizable parameter(s) are chosen to include, in addition to the permeabilities of the pipes (or the average permeability of the pipes) and the calibration coefficients for matching the magnitudes of the mutual impedance, the phase compensation values used to match the simulated phases for nominal sections with the measured phases. The response parameters are, in this case, the measured and simulated phases and magnitudes of the mutual impedance for the nominal section for at least one receiver and at least one frequency.

Instead of including the calibration coefficients to match the measured and simulated magnitudes of the mutual impedance among the optimizable parameters, these calibration coefficients can also be determined, following optimization of the magnetic permeabilities and/or phase compensation values, by forming the ratio of the simulated and measured magnitudes.

The magnitude of the mutual impedance for the calibrated simulated response and the measured response is employed, in accordance with various embodiments, to unwrap the phases when determining the phase variation versus total thickness using any one of the above-described embodiments. For large magnitude changes of the magnitude for the defective pipe sections relative to that for the nominal sections, proper multiples of 360 degrees may be added or subtracted from the simulated and measured phases.

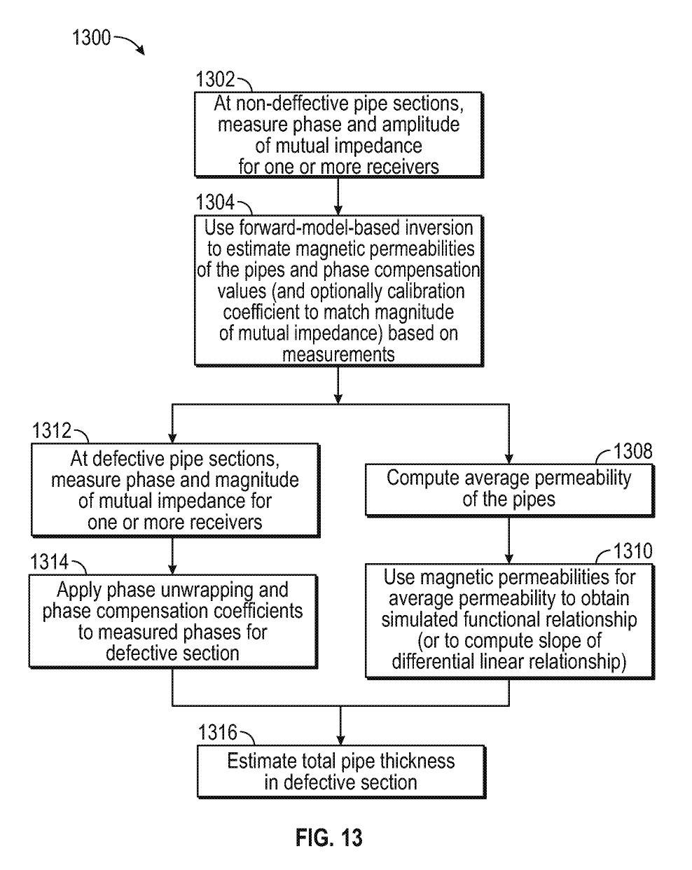

FIG. 13 is a flow chart illustrating a calibration process in accordance with some embodiments, integrated into a method 1300 for RFEC-based thickness determination. The method 1300 involves measuring the phase and amplitude of the mutual impedance at a non-defective pipe section (act 1302), and using forward-model-based inversion (e.g., as illustrated in FIG. 12) to estimate, from the measurements, the magnetic permeabilities of the pipes, the phase compensation values, and (optionally) calibration coefficients for matching the magnitudes (act 1304). The various estimated parameters can be determined simultaneously or sequentially, in accordance with any of the above-described schemes. The magnitude of the impedance can be used to unwrap the phase during the inversion. From the permeability estimates for the individual pipes, an average permeability may be computed (act 1308). Alternatively, as mentioned above, the inversion in act 1304 may directly solve for the average permeability. The average permeability, or alternatively the individual permeabilities of the pipes, are then used to obtain the appropriate simulated phase-thickness relationship (or, in alternative embodiments, to compute the slope of the differential linear relationship) (act 1310). Further, to determine the total pipe thickness for defective sections, the phase and magnitude of the mutual impedance are measured at the defective sections act 1312). The phase is unwrapped based on the magnitude of the mutual impedance, and phase compensation coefficients are applied (act 1314). From the unwrapped, compensated measured phases in conjunction with the simulated phase-thickness relationship (or, alternatively, the differential linear phase-thickness relationship), the total pipe thickness can then be estimated for the defective sections.

In various embodiments, as mentioned above, a simulated differential relationship between the difference phase of the mutual impedance (i.e., the phase measured relative to the phase for the nominal pipe section) and the change in total thickness (measured relative to the nominal thickness) is used. In this case, any mismatch between the measured and simulated phases is inherently subtracted out when computing the difference phases, and the determination of phase compensation values is, thus, rendered superfluous. In addition, the difference phase is less dependent on the magnetic permeability than the absolute phase, which can obviate the need to calibrate the magnetic permeability in some cases. Accordingly, the above-described calibration procedure may be omitted in some embodiments utilizing difference-phase measurements and a differential phase-thickness relationship.

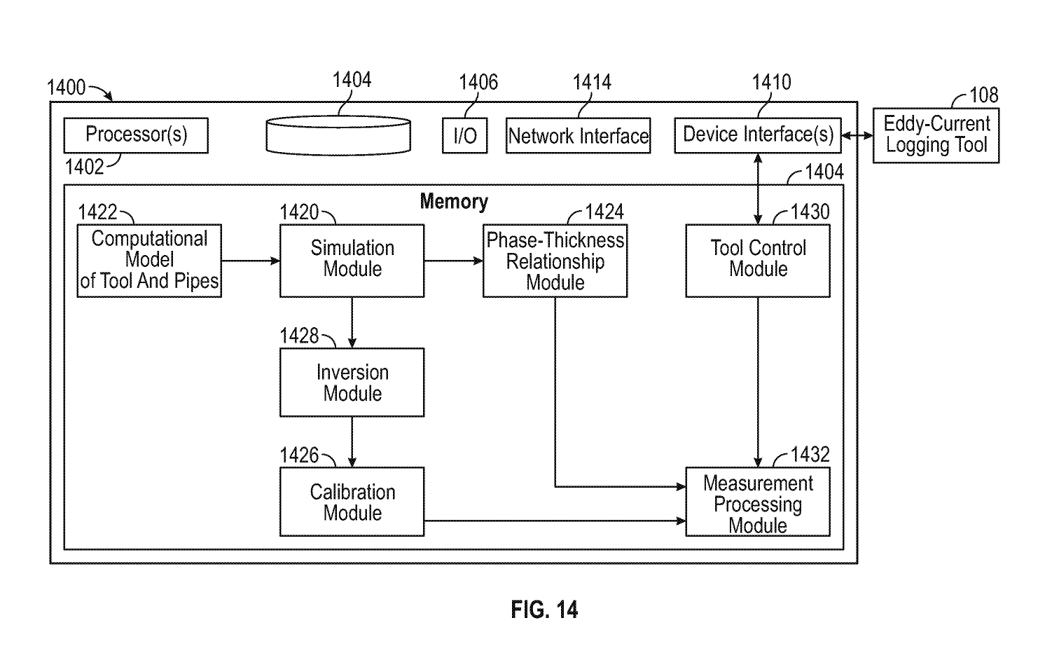

FIG. 14 is a block diagram of an example processing facility for the RFEC-based pipe thickness determination in accordance with various embodiments. The processing facility 1400 may be implemented, e.g., in a surface logging facility 116 or a computer communicating with the surface logging facility, or in processing circuitry 124 integrated into the electromagnetic logging tool 108. The processing facility 1400 includes one or more processors 1402 (e.g., a conventional central processing unit (CPU), graphical processing unit, or other) configured to execute software programs stored in memory 1404 (which may be, e.g., random-access memory (RAM), read-only memory (ROM), flash memory, etc.). In some embodiments, the processing facility 1400 further includes user input/output devices 1406 (e.g., a screen, keyboard, mouse, etc.), permanent data-storage devices 708 (including, e.g., solid-state, optical, and/or magnetic machine-readable media such as hard disks, CD-ROMs, DVD-ROMs, etc), device interfaces 1410 for communicating directly or indirectly with the eddy-current logging tool 108, a network interface 1414 that facilitates communication with other computer systems and/or data repositories, and a system bus (not shown) through which the other components of the processing facility 1400 communicate. The processing facility 1400 may, for example, be a general-purpose computer that has suitable software for implementing the computational methods described herein installed thereon. While shown as a single unit, the processing facility 1400 may also be distributed over multiple machines connected to each other via a wired or wireless network such as a local network or the Internet.

The software programs stored in the memory 1404 include processor-executable instructions for performing the methods described herein, and may be implemented in any of various programming languages, for example and without limitation, C, C++, Object C, Pascal, Basic, Fortran, Matlab, and Python. The instructions may be grouped into various functional modules. In accordance with the depicted embodiment, the modules include, for instance, a simulation module 1420 for computing the mutual impedance for a given pipe configuration with a given thickness (e.g., as described by a computational model 1422); a phase-thickness relationship module 1424 for determining the phase of the mutual impedance as a function of total thickness based on simulations performed by the simulation module 1420 for various thickness values, optionally in conjunction with interpolation and/or fitting to obtain an approximate piecewise linear or polynomial relationship; a calibration module 1426 for determining the magnetic permeabilities of the pipes (or an average permeability) and phase compensation values based on measurements taken at the nominal pipe sections; an inversion module 1428 used by the calibration module. (e.g., to implement the routine of FIG. 12), which may itself utilize the simulation module 1420; a tool-control module 1430 for obtaining mutual-impedance measurements from the eddy-current logging tool 108; and a measurement-processing module 1432 for unwrapping the measured phase of the mutual impedance and applying phase-compensation coefficients (if applicable), and for implementing the fast inversion of the phase of the mutual impedance to a total pipe thickness based on the simulated phase-thickness relationship. Of course, the computational functionality described herein can be grouped and organized in many different ways, the depicted grouping being just one example. Further, the various computational modules depicted in FIG. 14 need not all be part of the same software program or even stored on the same machine. Rather, certain groups of modules can operate independently of the others and provide data output that can be stored and subsequently provided as input to other modules. Further, as will be readily appreciated by those of ordinary skill in the art, software programs implementing the methods described herein (e.g., organized into functional modules as depicted in FIG. 14) may be stored, separately from any processing facility, in one or more non-volatile machine-readable media (such as, without limitation, solid-state, optical, or magnetic storage media), from which they may be loaded into (volatile) system memory of a processing facility for execution.

In general, the processing facility carrying out the computational functionality described herein (optionally as organized into various functional modules) can be implemented with any suitable combination of hardware, firmware, and/or software. For example, the processing facility may be permanently configured (e.g., with hardwired circuitry) or temporarily configured (e.g., programmed), or both in part, to implement the described functionality. A tangible entity configured, whether permanently and/or temporarily, to operate in a certain manner or to perform certain operations described herein, is herein termed a “hardware-implemented module” or “hardware module,” and a hardware module using one or more processors is termed a “processor-implemented module.” Hardware modules may include, for example, dedicated circuitry or logic that is permanently configured to perform certain operations, such as a field-programmable gate array (FPGA), application-specific integrated circuit (ASIC), or other special-purpose processor. A hardware module may also include programmable logic or circuitry, such as a general-purpose processor, that is temporarily configured by software to perform certain operations. Considering example embodiments in which hardware modules are temporarily configured, the hardware modules collectively implementing the described functionality need not all co-exist at the same time, but may be configured or instantiated at different times. For example, Where a hardware module comprises a general-purpose processor configured by software to implement a special-purpose module, the general-purpose processor may be configured for respectively different special-purpose modules at different times.

As shown in this disclosure, a single linear segment does not always provide an accurate representation of the variation of the phase of the mutual impedance as a function of total pipe thickness. The above-described approaches can be employed to improve the quality of inversion results using simulations, optionally approximating the phase variation with several linear segments or with a polynomial. In addition, measurements and simulations for multiple receivers and/or multiple frequencies may be used to further improve the estimate of the total thickness when using RFEC assumptions. Although the disclosed approaches involve simulations, they are, in many embodiments, still significantly faster than standard optimization-based inversion techniques. In the disclosed approaches, few evaluations of the model suffice to establish, for instance, the linear segments or the polynomial fit thereafter used to perform fast inversion of the measured phase to the total thickness of the pipes. On the other hand, in the standard optimization-based inversion approaches, many evaluations of the model are usually used to match the simulated and the measured responses and reach the optimal solution. Accordingly, the above-described methods provide an efficient way to estimate the total thickness of multiple pipes with improved accuracy, compared with that of conventional RFEC approaches that are based on the assumption of a linear phase-thickness relationship. The improved total-thickness estimate generally allows for better interpretation of the integrity of the production pipe and casings, which may, in turn, lead to significant financial advantages during the production process.

The performance of RFEC-based inversion as described herein is now illustrated with two examples.

### Example 1

In this inversion example, a logging tool with three receivers, e.g., as depicted in FIG. 7, is employed for the inspection of five pipes with outer diameters of 2+⅞ inches, 7 inches, 9+⅝ inches, 13+⅜ inches, and 18+⅝ inches and nominal thicknesses of 0.21 inches, 0.32 inches, 0.54 inches, 0.51 inches, and 0.43 inches, respectively. The relative magnetic permeabilities of the pipes are assumed to be estimated prior to simulating the phase-thickness relationship, and are taken to be 90. The measurements are assumed to be performed at 1 Hz and 2 Hz.

In two separate inversions, the 2^{nd} or the 5^{th} pipe, respectively, is assumed to change in thickness by 20% between the nominal and defective sections. The phase-thickness relationship is approximated with a piecewise linear function. Since the changes in the total thickness are very small (3.1% when the 2^{nd} pipe is defective, or 4.2% when the 5^{th} pipe is defective), the entire range of thicknesses spanned between the nominal and defective sections falls within a single linear segment; this is true for each receiver and at both frequencies. To evaluate the performance of the inversion method in the presence of noise, additive noise of 1 μV in measuring the real or imaginary part of the receiver voltages is assumed. Table 3 shows the relative error in the estimation of the total thickness of the defective section for defects in the 2^{nd} or 5^{th} pipe, and for combinations of total-thickness estimates across three, two, and a single receivers. The data shows that the use of multiple receivers to reduce the error is more effective when the outer pipes are defected (and may even be counterproductive for defects in the inner pipes, as in the instant example), due to the fact that the weaker response due to the thickness change on the outer pipes is more vulnerable to the noise such that the availability of additional information improves the quality of the inversion results.

TABLE 3
Error in estimation of the total thickness of detective pipe section

| Employed Receivers | RX1 to RX3 | RX2 and RX3 | RX3 only |
|---|---|---|---|
| Defected 2^{nd} pipe | 8.4% | 8.4% | 8.1% |
| Defected 5^{th} pipe | 3.6% | 3.7% | 6.6% |

### Example 2

In the second inversion example, measurements are performed at 1 Hz with a logging tool similar to that of FIG. 7, but using only receiver RX3, to measure the total thickness of four pipes with outer diameters of 7 inches, 9+⅝ inches, 13+⅜ inches, and 18+⅝ inches and nominal thicknesses of 0.32 inches, 0.54 inches, 051 inches, and 0.43 inches, respectively. The defective region is on pipe 4 and consists of a thickness reduction of 0.135 inches for a length of six feet followed by a thickness reduction of 0.03 inches for a length of one foot.

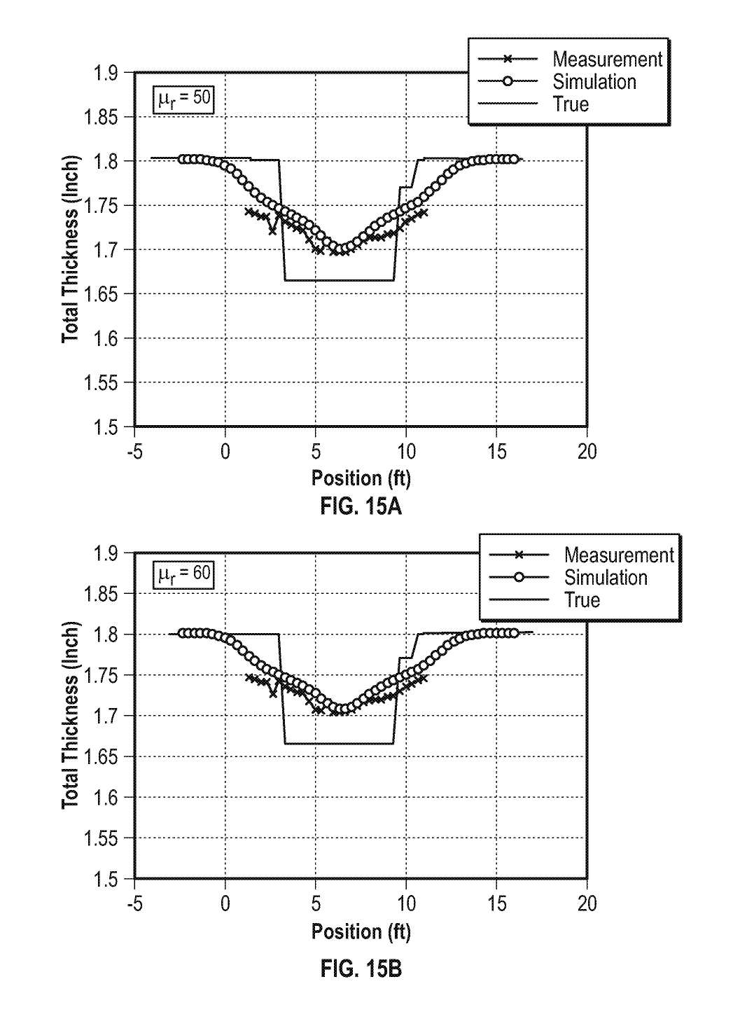

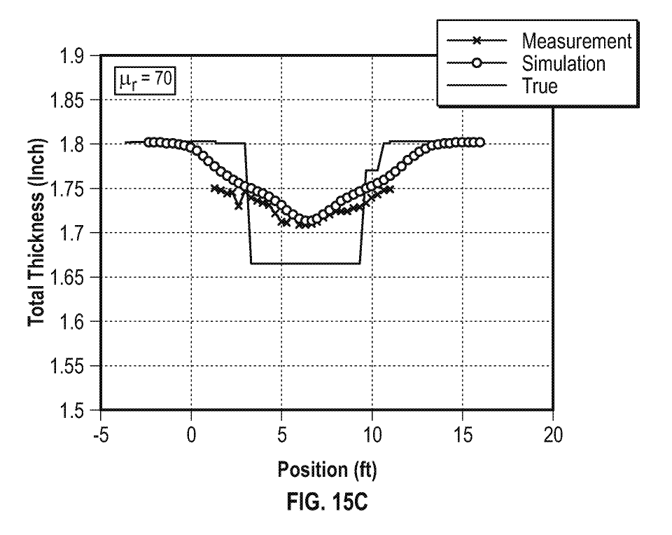

FIGS. 15A-15C show, for respective relative magnetic permeabilities of 50, 60, and 70 for all pipes, the true total thickness of the four pipes as a function of the axial position along the pipes, as well as the total thickness versus axial position as estimated by inversion from the measured or simulated change in the phase of the mutual impedance relative to the phase of the mutual impedance for the nominal pipe sections, using a simulated functional relationship between the change in the phase and the change in total thickness relative to the nominal total thickness. A comparison of the results for these three cases confirms that the total-thickness estimation is not very sensitive to the relative magnetic permeabilities of the pipes. However, for fewer pipes or larger differences between the true and assumed permeabilities of the pipes, estimating the true permeabilities of the pipes as described above may provide more accurate results. Due to practical issues, the change in phase has been measured in the instant example only over a limited range of axial positions, but the simulated and the measured total-thickness estimations match well. The error in the estimation of the total thickness is about 2-4% for both measured and simulated results and for all three values of the magnetic permeability. The length of the estimated detective region is greater than the true length of the defective region, and the technique is not very sensitive to small thickness variations. Therefore, the one-foot-long and the six-feet-long defective regions cannot be readily distinguished in the graphs.

The following numbered examples are illustrative embodiments.

1. A method comprising: using an eddy-current logging tool disposed interior to a set of nested pipes, measuring a phase of a mutual impedance between a transmitter and a receiver of the tool for a nominal section of the pipes and for a defective section of the pipes, the nominal section having an associated nominal total thickness; obtaining a simulated functional relationship, computed based on a model of the set of nested pipes, between a change in the phase of the mutual impedance measurable for the pipes relative to the phase of the mutual impedance measurable for the nominal section and a change in total thickness of the pipes relative to the nominal total thickness; and computing a reduction in total thickness of the pipes in the defective section relative to the nominal total thickness based on the simulated functional relationship and a difference between values of the phase measured for the nominal and defective sections.

2. The method of example 1, wherein the simulated functional relationship is computed prior to measuring the phase of the mutual impedance, and the reduction in total thickness of the pipes is computed for multiple axial positions within one or more defective sections of the pipes based on the simulated functional relationship and multiple respective values of the phase of the mutual impedance measured for the multiple axial positions.

3. The method of example 1 or example 2, wherein the simulated functional relationship is a piecewise linear function computed by linear interpolation between at least three values of the change in the phase of the mutual impedance for at least three respective values of the change in total thickness of the pipes.

4. The method of example 1 or example 2, wherein the simulated functional relationship comprises a polynomial of at least second order fitted to at least three values of the change in the phase of the mutual impedance for at least three respective values of the change in total thickness of the pipes.

5. The method of any one of the preceding examples, wherein the phase of the mutual impedance is measured, and the simulated functional relationship is obtained, for at least one of multiple frequencies or multiple receivers placed at multiple respective distances from the transmitter, the reduction in total thickness being computed based on the multiple measured phases and the multiple functional relationships used in combination.

6. The method of example 5, wherein the reduction in total thickness is computed by averaging over multiple values of the reduction in total thickness computed separately based on the multiple respective measured phases and the multiple respective functional relationships.

7. The method of example 6, wherein the averaging comprises applying weighting coefficients to the multiple separately computed values of the reduction in total thicknesses, each weighting coefficient depending on at least one of the frequency for which the respective phase was measured or a distance of the transmitter from the receiver for which the respective phase was measured.

8. The method of example 7, wherein each weighting coefficient further depends on at least one of a number of the pipes, the diameter of the pipes, the nominal total thickness of the pipes, magnetic permeabilities of the pipes, or electrical conductivities of the pipes.

9. The method of example 5, wherein the reduction in total thickness is computed by minimizing a cost function aggregating, across the multiple frequencies or the multiple receivers, a deviation of the difference between the phases measured for the nominal and detective sections and a corresponding phase difference computable from the reduction in total thickness using the simulated functional relationship for the respective frequency and receiver.

10. The method of example 9, wherein the cost function comprises weighting coefficients dependent on at least one of the frequency for which the respective phase was measured or a distance of the transmitter from the receiver for which the respective phase was measured.

11. A system comprising: an eddy-current logging tool for disposal interior to a set of nested pipes, the tool comprising a transmitter, at least one receiver, and circuitry for measuring a phase of a mutual impedance between the transmitter and the at least one receiver; and a processing facility configured to compute a reduction in total thickness of the pipes in a defective section relative to a nominal total thickness of a nominal section based on (i) a difference between values of the phase of the mutual impedance measured for the nominal and defective sections, respectively, and (ii) a simulated functional relationship, computed based on a model of the set of nested pipes, between a change in the phase of the mutual impedance measurable for the pipes relative to the phase of the mutual impedance measurable for the nominal section and a change in total thickness of the pipes relative to the nominal total thickness.

12. The system of example 11, wherein the simulated functional relationship is a piecewise linear function computed by linear interpolation between at least three values of the change in the phase of the mutual impedance for at least three respective values of the change in total thickness of the pipes.

13. The system of example 11, wherein the simulated functional relationship comprises a polynomial of at least second order fitted to at least three values of the change in the phase of the mutual impedance for at least three respective values of the change in total thickness of the pipes.

14. The system of any one of examples 11-13, wherein the eddy-current logging tool is configured to measure multiple phases of the mutual impedance for at least one of multiple receivers of the tool or multiple frequencies, and the processing facility is configured to obtain multiple simulated functional relationships for the multiple receivers or frequencies, and to compute the reduction in total thickness based on the multiple measured phases and the multiple simulated functional relationships used in combination.

15. The system of example 14, wherein the processing facility is configured to compute the reduction in total thickness by averaging over multiple values of the reduction in total thickness computed separately based on the multiple respective measured phases and the multiple respective functional relationships.

16. The system of example 15, wherein the processing facility is configured to apply weighting coefficients to the multiple separately computed values of the reduction in total thicknesses, each weighting coefficient depending on at least one of the frequency for which the respective phase was measured or a distance of the transmitter from the receiver for which the respective phase was measured.

17. The system of example 16, wherein each weighting coefficient further depends on at least one of a number of the pipes, the diameter of the pipes, the nominal total thickness of the pipes, magnetic permeabilities of the pipes, or electrical conductivities of the pipes.

18. The system of example 14, wherein the processing facility is configured to compute the reduction in total thickness by minimizing a cost function aggregating, across the multiple frequencies or the multiple receivers, a deviation of the difference between the phases measured for the nominal and defective sections and a corresponding phase difference computable from the reduction in total thickness using the simulated functional relationship for the respective frequency and receiver.

19. The system of example 18, wherein the cost function comprises weighting coefficients dependent on at least one of the frequency for which the respective phase was measured or a distance of the transmitter from the receiver for which the respective phase was measured.

20. A tangible machine-readable medium for processing measurements, by an eddy-current logging tool disposed interior to a set of nested pipes, of a phase of a mutual impedance between a transmitter and a receiver of the tool, the tangible machine-readable medium having embodied thereon instructions that, when executed by a machine, cause the machine to: compute a reduction in total thickness of the set of nested pipes in a detective section thereof relative to a nominal total thickness of a nominal section of the set of nested pipes based on (i) a difference between values of the phase of the mutual impedance measured for the nominal and defective sections, respectively, and (ii) a simulated functional relationship, computed based on a model of the set of nested pipes, between a change in the phase of the mutual impedance measurable for the pipes relative to the phase of the mutual impedance measurable for the nominal section and a change in total thickness of the pipes relative to the nominal total thickness.

Many variations may be made in the systems, tools, and methods described and illustrated herein without departing from the scope of the inventive subject matter. Accordingly, the specific embodiments and examples described are intended to be illustrative and not limiting.

What is claimed is:

1. A method comprising:
using an eddy-current logging tool disposed interior to a set of nested pipes, measuring a phase of a mutual impedance between a transmitter and a receiver of the tool for a nominal section of the pipes and for a defective section of the pipes, the nominal section having an associated nominal total thickness;
obtaining a simulated functional relationship, computed based on a model of the set of nested pipes, between a change in the phase of the mutual impedance measurable for the pipes relative to the phase of the mutual impedance measurable for the nominal section and a change in total thickness of the pipes relative to the nominal total thickness; and
computing a reduction in total thickness of the pipes in the defective section relative to the nominal total thickness based on the simulated functional relationship and a difference between values of the phase measured for the nominal and defective sections.

2. The method of claim 1, wherein the simulated functional relationship is computed prior to measuring the phase of the mutual impedance, and the reduction in total thickness of the pipes is computed for multiple axial positions within one or more defective sections of the pipes based on the simulated functional relationship and multiple respective values of the phase of the mutual impedance measured for the multiple axial positions.

3. The method of claim 1, wherein the simulated functional relationship is a piecewise linear function computed by linear interpolation between at least three values of the change in the phase of the mutual impedance for at least three respective values of the change in total thickness of the pipes.

4. The method of claim 1, wherein the simulated functional relationship comprises a polynomial of at least second order fitted to at least three values of the change in the phase of the mutual impedance for at least three respective values of the change in total thickness of the pipes.

5. The method of claim 1, wherein the phase of the mutual impedance is measured, and the simulated functional relationship is obtained, for at least one of multiple frequencies or multiple receivers placed at multiple respective distances from the transmitter, the reduction in total thickness being computed based on the multiple measured phases and the multiple functional relationships used in combination.

6. The method of claim 5, wherein the reduction in total thickness is computed by averaging over multiple values of the reduction in total thickness computed separately based on the multiple respective measured phases and the multiple respective functional relationships.

7. The method of claim 6, wherein the averaging comprises applying weighting coefficients to the multiple separately computed values of the reduction in total thicknesses, each weighting coefficient depending on at least one of the frequency for which the respective phase was measured or a distance of the transmitter from the receiver for which the respective phase was measured.

8. The method of claim 7, wherein each weighting coefficient further depends on at least one of a number of the pipes, the diameter of the pipes, the nominal total thickness of the pipes, magnetic permeabilities of the pipes, or electrical conductivities of the pipes.

9. The method of claim 5, wherein the reduction in total thickness is computed by minimizing a cost function aggregating, across the multiple frequencies or the multiple receivers, a deviation of the difference between the phases measured for the nominal and defective sections and a corresponding phase difference computable from the reduction in total thickness using the simulated functional relationship for the respective frequency and receiver.

10. The method of claim 9, wherein the cost function comprises weighting coefficients dependent on at least one of the frequency for which the respective phase was measured or a distance of the transmitter from the receiver for which the respective phase was measured.

11. A system comprising:
an eddy-current logging tool for disposal interior to a set of nested pipes, the tool comprising a transmitter, at least one receiver, and circuitry for measuring a phase of a mutual impedance between the transmitter and the at least one receiver; and
a processing facility configured to compute a reduction in total thickness of the pipes in a defective section relative to a nominal total thickness of a nominal section based on (i) a difference between values of the phase of the mutual impedance measured for the nominal and defective sections, respectively, and (ii) a simulated functional relationship, computed based on a model of the set of nested pipes, between a change in the phase of the mutual impedance measurable for the pipes relative to the phase of the mutual impedance measurable for the nominal section and a change in total thickness of the pipes relative the nominal total thickness.

12. The system of claim 11, wherein the simulated functional relationship is a piecewise linear function computed by linear interpolation between at least three values of the change in the phase of the mutual impedance for at least three respective values of the change in total thickness of the pipes.

13. The system of claim 11, wherein the simulated functional relationship comprises a polynomial of at least second order fitted to at least three values of the change in the phase of the mutual impedance for at least three respective values of the change in total thickness of the pipes.

14. The system of claim 11, wherein the eddy-current logging tool is configured to measure multiple phases of the mutual impedance for at least one of multiple receivers of the tool or multiple frequencies, and the processing facility is configured to obtain multiple simulated functional relationships for the multiple receivers or frequencies, and to compute the reduction in total thickness based on the multiple measured phases and the multiple simulated functional relationships used in combination.

15. The system of claim 14, wherein the processing facility is configured to compute the reduction in total thickness by averaging over multiple values of the reduction in total thickness computed separately based on the multiple respective measured phases and the multiple respective functional relationships.

16. The system of claim 15, wherein the processing facility is configured to apply weighting coefficients to the multiple separately computed values of the reduction in total thicknesses, each weighting coefficient depending on at least one of the frequency for which the respective phase was measured or a distance of the transmitter from the receiver for which the respective phase was measured.

17. The system of claim 16, wherein each weighting coefficient further depends on at least one of a number of the pipes, the diameter of the pipes, the nominal total thickness of the pipes, magnetic permeabilities of the pipes, or electrical conductivities of the pipes.

18. The system of claim 14, wherein the processing facility is configured to compute the reduction in total thickness by minimizing a cost function aggregating, across the multiple frequencies or the multiple receivers, a deviation of the difference between the phases measured for the nominal and defective sections and a corresponding phase difference computable from the reduction in total thickness using the simulated functional relationship for the respective frequency and receiver.

19. The system of claim 18, wherein the cost function comprises weighting coefficients dependent on at least one of the frequency for which the respective phase was measured or a distance of the transmitter from the receiver for which the respective phase was measured.

20. A tangible machine-readable medium for processing measurements, by an eddy-current logging tool disposed interior to a set of nested pipes, of a phase of a mutual impedance between a transmitter and a receiver of the tool, the tangible machine-readable medium having embodied thereon instructions that, when executed by a machine, cause the machine to:
compute a reduction in total thickness of the set of nested pipes in a defective section thereof relative to a nominal total thickness of a nominal section of the set of nested pipes based on (i) a difference between values of the phase of the mutual impedance measured for the nominal and defective sections, respectively, and (ii) a simulated functional relationship, computed based on a model of the set of nested pipes, between a change in the phase of the mutual impedance measurable for the pipes relative to the phase of the mutual impedance measurable for the nominal section and a change in total thickness of the pipes relative to the nominal total thickness.
